(19) United States
(12) Patent Application Publication
(10) Pub. No.: US 2007/0136268 A1
(43) Pub. Date: Jun. 14, 2007

(54) Just in time loading list

(75) Inventors: Imran I. Qureshi, Milpitas, CA (US); Brian R. Tunning, San Francisco, CA (US); Michael A. Starbird, San Francisco, CA (US)

Correspondence Address: VIERRA MAGEN/MICROSOFT CORPORATION, 575 MARKET STREET, SUITE 2500, SAN FRANCISCO, CA, 94105, US

(73) Assignee: Microsoft Corporation, Redmond, WA (US)

(21) Appl. No.: 11/329,510

(22) Filed: Jan. 11, 2006

Related U.S. Application Data
(60) Provisional application No. 60/748,738, filed on Dec. 9, 2005.

(51) Int. Cl. G06F 17/30

(52) U.S. Cl. 707/4

(57) ABSTRACT

Some applications require the use of a long list of items. For example, an email application may have a long list of emails or an online banking application may have a long list of transactions. A problem arises, however, when there are many items in the list because it may take too long to download all of the data. To overcome this problem, a technology is proposed that creates a list with a placeholder for each of the elements in the list. As portions of the list are needed (or viewed), the relevant data is downloaded and used to populate the relevant items in the list.

### CLAIM OF PRIORITY

This application claims the benefit of U.S. Provisional Application No. 60/748,738, “Just In Time Loading List,” filed on Dec. 9, 2005, incorporated herein by reference in its entirety.

### BACKGROUND

The evolution of computers and networking technologies from high-cost, low performance data processing systems to low cost, high-performance communication, problem solving, and entertainment systems has provided a cost-effective and time saving means to lessen the burden of performing every day tasks such as correspondence, bill paying, shopping, budgeting, information gathering, etc. For example, a computing system interfaced to the Internet, by way of wire or wireless technology, can provide a user with a channel for nearly instantaneous access to a wealth of information and services.

Typically, the information and services available from websites and servers are accessed by way of a web browser executing on a client (e.g., a computer). For example, a web user can deploy a web browser and access a web site by entering the web site Uniform Resource Locator (URL) into an address bar of the web browser. The web browser will then receive HTML code from the server that the web browser will execute in order to implement a web page within the browser.

A scrollable list is a common user interface element on web sites. It allows for sequential access to elements and also random access. Users can easily go to an element at the beginning, middle, or end of the list. However, if there are too many items in the list it will take a very long time to download all the elements and take too much bandwidth of the server. Hence web sites tend to only use scrollable lists for scenarios where the number of items is small. In scenarios where there is a need for a large number of items, web sites sometimes use a paging model instead of a scrolling model. This makes it hard to access elements at random and is harder to use.

### SUMMARY

A technology is described for implementing a list that can contain many items and will not suffer from the performance issues or page refresh requirements described above. A list is created with placeholders for each of the elements in the list. As portions of the list are needed (or viewed), the relevant data is downloaded and used to populate the items in the list which have been moved into view. Because the list has placeholders for each of the items that have not been populated with data, the user is able to perform actions on the items in the list, even if data has not yet been downloaded for the items. For example, a user may be scrolling down while holding the shift key (performing multiselect on many items which have not yet been downloaded or “fetched”) and presses the delete key to delete the items before the data for the items (names and values, for example) has been downloaded.

One embodiment includes providing a representation of a list that depicts items in the list that have not been populated with data, receiving a request to perform an action on an item that has not been populated with data, and facilitating performance of the action on the item.

Another embodiment includes providing a representation of the list that depicts items in the list that have not been populated with data and filling in data for items that have not been populated with data after providing the representation of the list.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram depicting one embodiment of the components used to implement the technology described herein.

FIG. 1B is a block diagram depicting one embodiment of the components used to implement the technology described herein.

FIG. 2 is a block diagram of a computing system.

FIG. 3A is a flowchart describing one embodiment of a process for creating a list.

FIG. 3B is a flowchart describing one embodiment of a process for creating a list.

FIG. 4 is a block diagram of code for a page.

FIG. 5 is a block diagram of the components of one embodiment of the list code depicted in FIG. 4.

FIG. 6 depicts an example of a list.

FIGS. 7A and 7B depict embodiments of items in a list.

FIG. 8 is a flowchart describing one embodiment of a process for scrolling within a list.

FIG. 9 is a flowchart describing one embodiment of a process performed when an item on a list is selected.

FIG. 10 is a flowchart describing one embodiment of a process performed when an item in a list is selected.

FIG. 11 is a flowchart describing one embodiment of a process performed when a pointing device hovers over an item in a list.

FIG. 12 is a flowchart describing one embodiment of a process for deleting an item in a list.

FIG. 13 is a flowchart describing one embodiment of a process for inserting an item into a list.

FIGS. 14A and 14B are examples of a user interface.

FIG. 15 is one example of a user interface.

### DETAILED DESCRIPTION

A technology is described for implementing a list that can contain many items. This list will not suffer from performance issues or require page refresh to scroll within the list. The list is initially created with placeholders for each of the elements. As portions of the list are needed (or viewed), the relevant data is downloaded and used to populate the relevant items in the list. Because the list has placeholders for each of the items that have not been populated with data, the user is able to see how big the list is and perform actions on the items in the list, even if data has not been downloaded for all of the items.

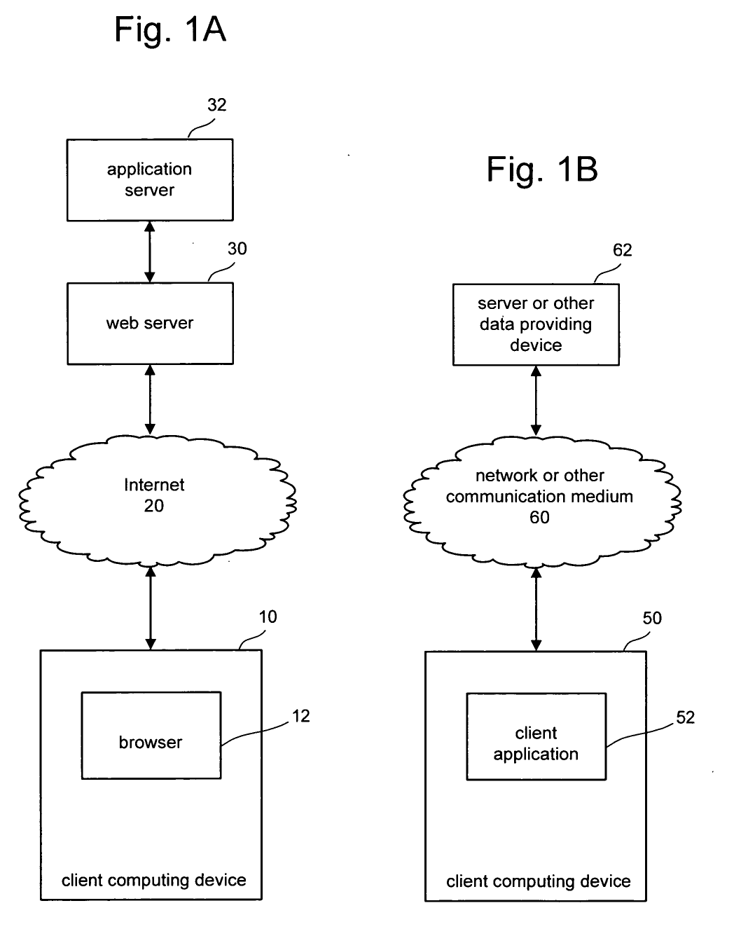

There are many different embodiments for implementing the lists described herein. In one set of implementations depicted in FIG. 1A, the technology is used as a part of a web service or web application. Such a system would include a client computing device 10 running a web browser 12. Browser 12 can be Internet Explorer from Microsoft Corporation or a different Internet browser. Computing device 10 (using browser 12) communicates via the Internet 20 (or other network) with web server 30. Web server 30 serves as an interface for a particular web service or application. That web service or application will be implemented by application server 32. In one embodiment, application server 32 includes one or more servers, one or more database systems and/or other components necessary to implement a particular service or application. One example of such a service can be a web based email service. One example of a web based email service is Hotmail from Microsoft Corporation or Windows Live Mail from Microsoft Corporation. Other web based email services can also be used with the technology described herein. Application server 32 can also be used to implement other services such as online banking, searching, electronic commerce, etc. The technology described herein for providing lists is not restricted to any particular service or application.

FIG. 1B is a block diagram of another embodiment of a system that utilizes the technology described herein for providing lists. The embodiment of FIG. 1B contemplates the list being used by an application 52 resident on client computing device 50. This client application 52 would obtain data from a server 62 (or other data providing device, such as a database system) via network 60 (or other communication medium). In one embodiment, client application 52 communicates with server 62 via a local area network. In other embodiments, the communication can be over a WAN, can be wireless, or can be other means.

In the embodiments of FIGS. 1A and 1B, browser 12 and client application 52 need to present a list of items faster than the data can be provided to browser 12 or client application 52. Therefore, the technology described herein is used to implement the list.

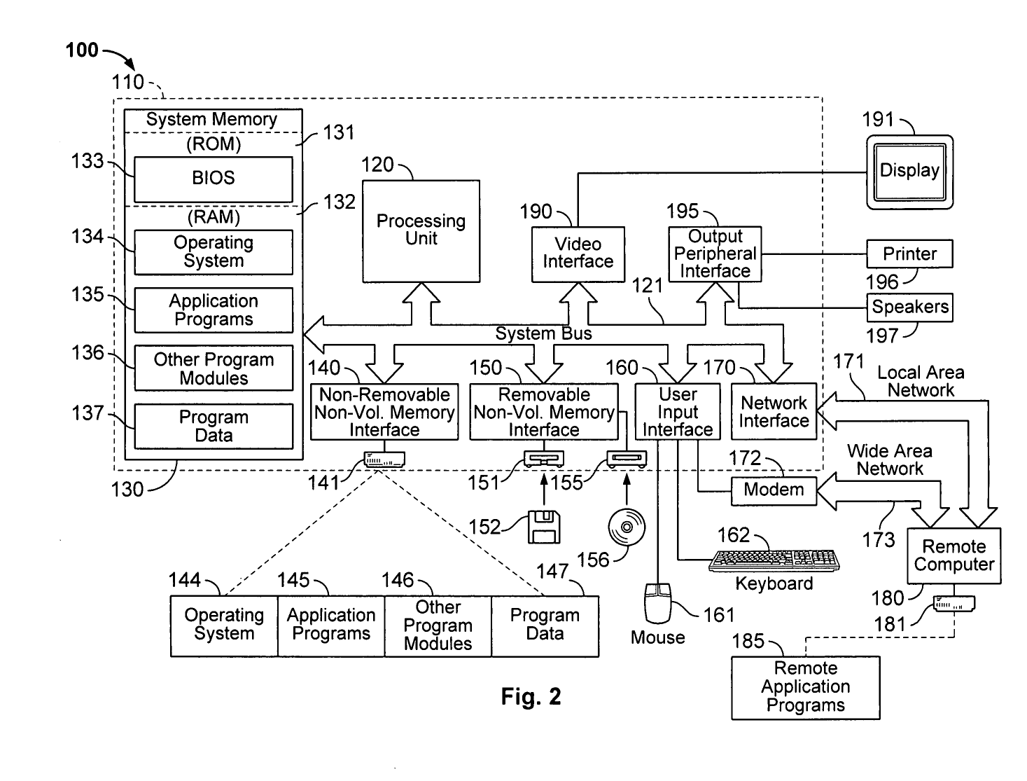

FIG. 2 illustrates one example of a suitable general computing environment 100 that may be used to implement the various components illustrated in FIGS. 1A and 1B. Computing system 100 is only one example of a suitable computing environment and is not intended to suggest any limitation as to the scope of use or functionality of the technology described herein. Neither should computing system 100 be interpreted as having any dependency or requirement relating to any one or combination of components illustrated in the exemplary operating environment 100.

The technologies described herein are operational with numerous other general purpose or special purpose computing system environments or configurations. Examples of well known computing systems, environments, and/or configurations that may be suitable for use include, but are not limited to, personal computers, server computers, hand-held or laptop devices, personal digital assistants, telephones (wired, wireless, or cellular), multiprocessor systems, microprocessor-based systems, set top boxes, programmable consumer electronics, network PCs, minicomputers, mainframe computers, distributed computing environments that include any of the above systems or devices, and the like.

The system may be described in the general context of computer-executable instructions, such as program modules, being executed by a computer. Generally, program modules include routines, programs, objects, components, data structures, etc., that perform particular tasks or implement particular abstract data types. The system may also be implemented in distributed computing environments where tasks are performed by remote processing devices that are linked through a communications network. In a distributed computing environment, program modules may be located in both local and remote computer storage media including memory storage devices.

With reference to FIG. 2, an exemplary system includes a general purpose computing device in the form of a computer 110. Components of computer 110 may include, but are not limited to, a processing unit 120 (which can include multiple processors), a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data to program the processor(s) to perform the methods described herein. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, computer 110 is connected to LAN 171 through a network interface or adapter 170. When used in a WAN networking environment, computer 110 typically includes a modem 172, network interface or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181. It will be appreciated that the network connections shown are exemplary and other means of establishing a communications link between the computers may be used.

Display 191 of system 100 depicted in FIG. 2 can include multiple monitors. For example, FIG. 2 shows display 191 comprising 18 monitors 201, 202, 203, 204, 205, 206, 207, 208, 209, 210, 211, 212, 213, 214, 215, 216, 217, and 218. In one embodiment, the monitors are arranged in three rows and six columns; however, other arrangements can also be used. In addition, display 191 can include less than 18 monitors or more than 18 monitors. Each monitor can be the same size or different sizes. Monitors 201-218 can be any suitable size known or used in the art. The monitors can be LCD monitors, CRT monitors or other types of monitors. In one embodiment, each of the monitors 201-218 displays a different portion of the computer screen. In other embodiments, two or more of the monitors can overlap in displaying portions of the computer screen.

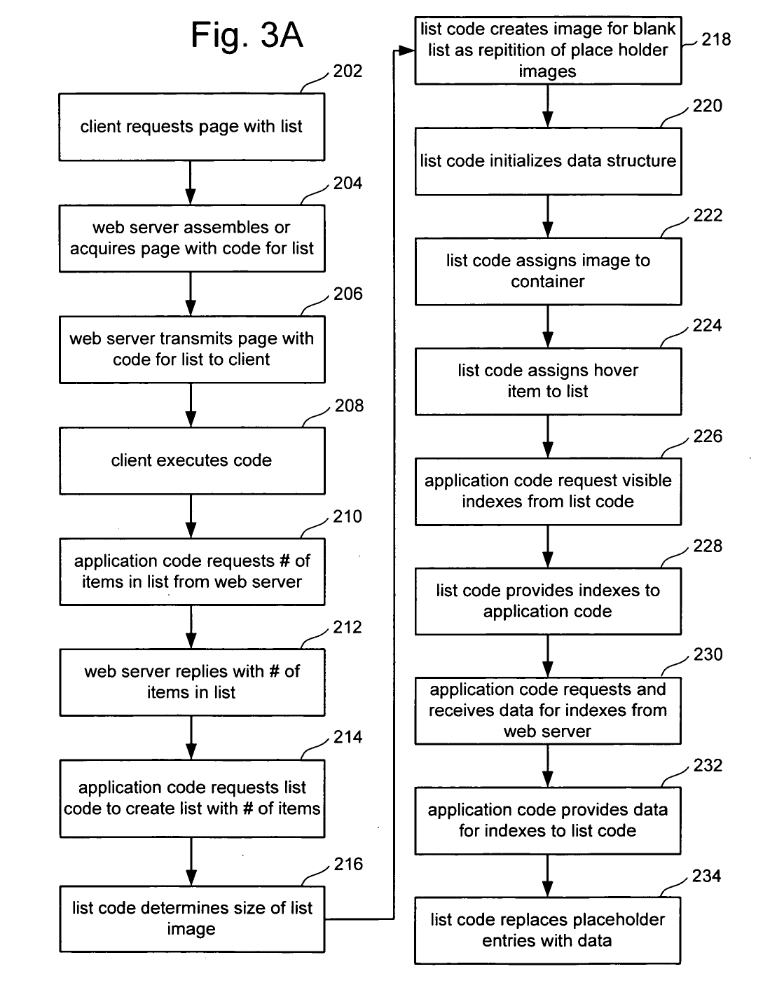

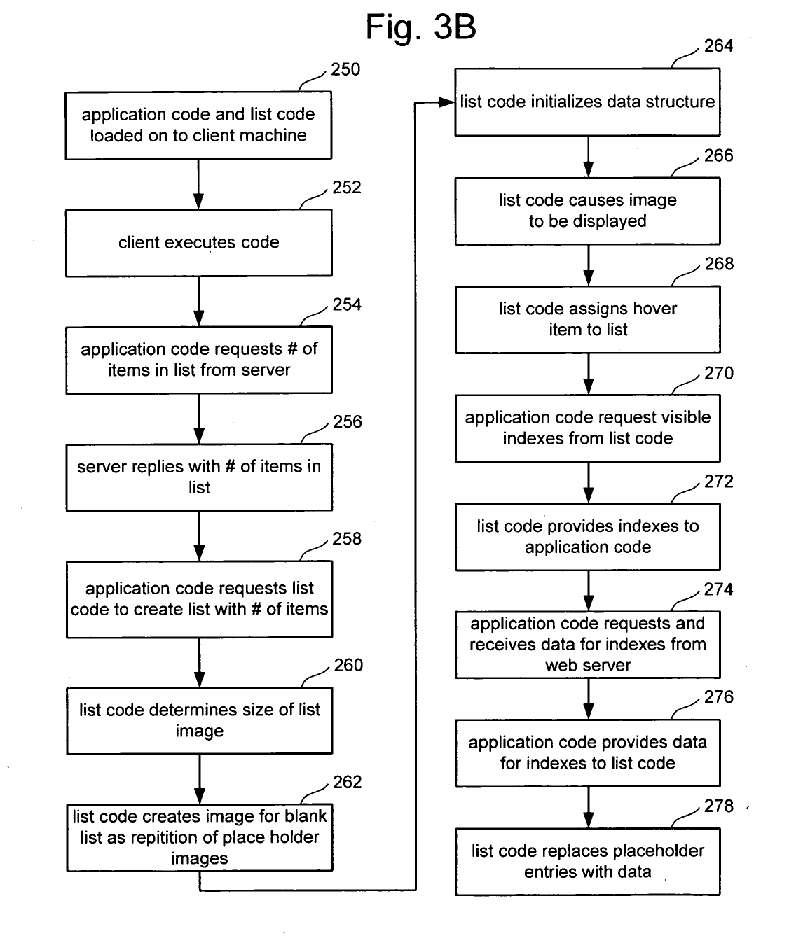

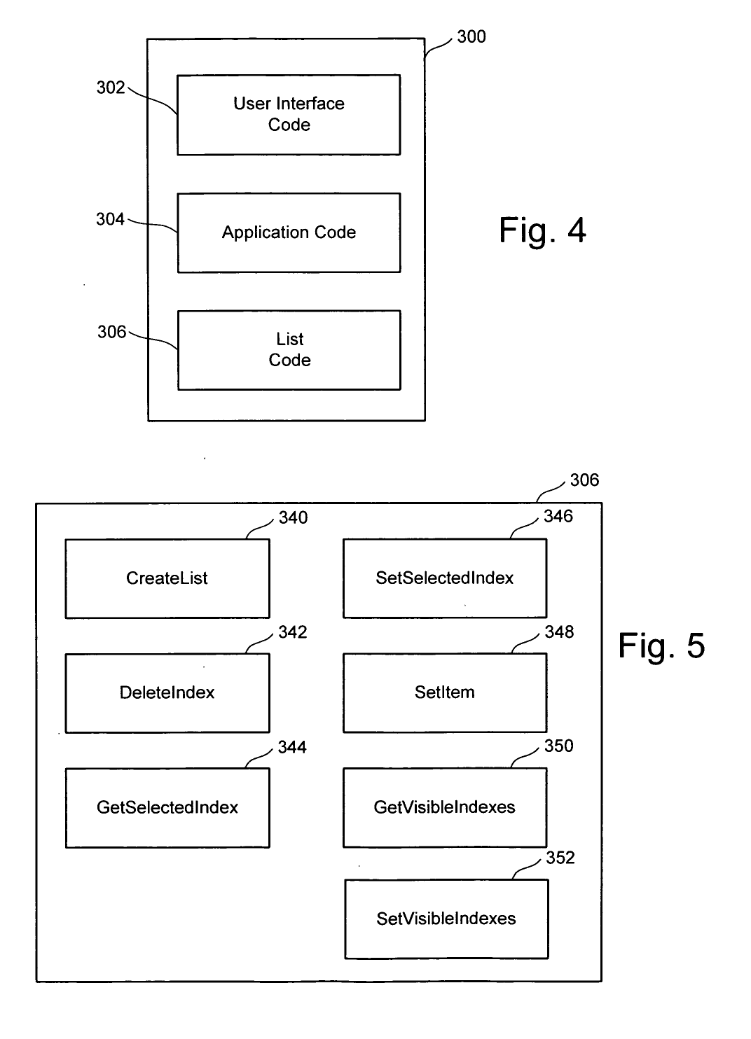

FIG. 3A is a flowchart describing one embodiment of a process for creating a list to be used in a user interface implemented in browser 12 of computing device 10 (see FIG. 1A). In step 202 of FIG. 3A, client 10 (using browser 12) requests a web page that includes a list with many items. In step 204, web server 30 assembles or acquires the code for the page, including code for the list. In step 206, web server 30 transmits the page and the code for the list to client 10 for implementation in browser 12. In one embodiment, the code for the web page is HTML code. This HTML code includes JavaScript code for implementing the list. FIG. 4 is a block diagram depicting one example of code 300 for implementing the web page. In this embodiment, code 300 includes user interface code 302, application code 304, and list code 306. User interface code 302 is HTML code used to implement the user interface. Other type of code can also be used to implement the user interface. Application code 304 is used to coordinate between web server 30, interface code 302 and list code 306 to provide application's specific functionality. In one embodiment, application code 304 is JavaScript; however, other types of code can also be used. List code 306 manages the list. In one embodiment, list code 306 is JavaScript; however, other types of code can also be used. In one embodiment, asynchronous JavaScript and XML (AJAX) can be used to allow updates to be performed without having to go to a new page. Thus, the list can be managed (including adding items, deleting items, selecting items and performing actions on items) without the page refresh that is typical of web-based applications.

FIG. 5 provides more detail of list code 306. In one embodiment, list code 306 includes at least seven modules; CreateList module 340, DeleteIndex module 342, GetSelectedIndex module 342, SetSelectedIndex module 346, SetItem 348, GetVisibleIndexes module 350, and SetVisibleIndexes module 352. These modules can be accessed by application code 304. List code 350 includes other functions that are used by the above described six modules or that are otherwise used to maintain the list. CreateList module 340 is used to initialize and create a new list. One argument passed to CreateList module 340 is the list size. DeleteIndex module 342 is the function that removes a specified item from the list. The item removed corresponds to the index passed as an argument to the module. GetSelectedIndex module 344 returns the index number of the selected item in the list. Each item in the list has an index number. For example, if there are 10 items in the list, the indices will go from 0 9, with 0 being the first item and 9 being the last item. The GetSelectedIndex module 344 returns the index for the item selected by the user. The SetSelectedIndex module 346 causes the item in the list associated with the index passed into the module to be the selected item in the list. SetItem module 348 receives an index value as an argument and a pointer to data. The data pointed to by the pointer is loaded into the list for the item corresponding to the index passed as an argument. GetVisibleIndices module 350 returns upper and lower indices of the items in the list that currently are visible. As discuss below, the entire list is not visible at any one time. Thus, the visible portion of the list will be identified from a lower index and an upper index. These two indices are returned from the GetVisibleIndex module function 350. The SetVisibleIndex module 352 causes the list to scroll to a particular index.

Upon receiving code 300 in step 206 of FIG. 3A, client 10 will execute that code in step 208. In step 210, application code 304 will send a request to web server 30 asking how many items are in the list. In step 210, web server 30 will reply with the number of items in the list. In step 214, application code 304 requests that list code 306 create a new list with the number of items corresponding to the amount specified by web server 30 in step 212. As part of step 214, application code 304 will call CreateList module 340, passing in as an argument the number of items in the list. In step 216, list code 306 will determine the size of the list. In one embodiment, the list is depicted as an image (e.g., a GIF). The system will have a preconfigured height for each item in the list. Thus, list code 306 will determine the size of the list image by multiplying the number of items in the list by the height per item. The width of the list will be fixed.

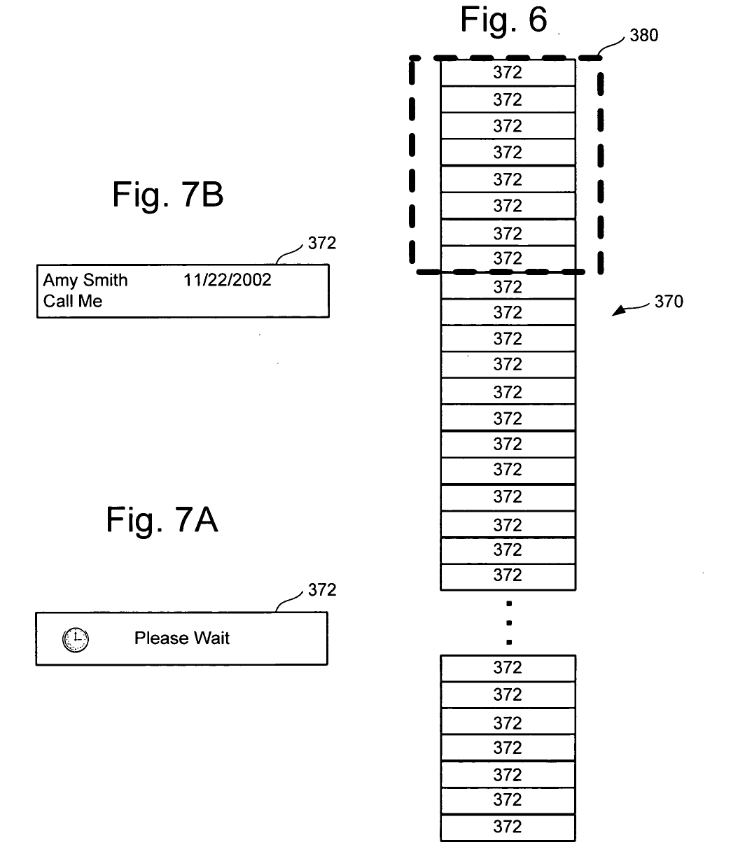

In step 218 of FIG. 3A, list code 306 will create the initial list. In one embodiment, the list is represented as an image. Thus, each item is also an image. When the list is initialized, there is no data for any of the items. Therefore, each item is represented as a placeholder image. This placeholder image is the width of the list and the height of one item. The placeholder image is replicated for each item in the list. Thus, if there are 200 items in the list, there will be 200 copies of the placeholder image stacked adjacent to each other. FIG. 6 depicts an example list 370 that includes a number of items 372. When the list is initially created, each item 372 will be depicted by a placeholder image in the form depicted in FIG. 7A, which includes text asking the user to “Please Wait” and an image of a clock.

FIG. 6 also shows a rectangle 380, which is used to indicate the portion of the list that is visible. Thus, those items within rectangle 380 are visible. The remainder of the items are not visible. When items become visible, the system will acquire the data for the visible items from server 30 and replace the placeholder images for those items with data images. When the system receives data for an item, the image of the item will be changed to the data image form depicted in FIG. 7B. In one embodiment, when data is obtained for an item, a new image is created which is the same size as an image for one item in the list. This image will include the data obtained for that item. That new image for the item with the populated data will then be overlaid on top of the image for the entire list, at the appropriate location for the item (based on the index). Note that FIGS. 7A and 7B are one set of examples of images. Other images can also be used.

Looking back at FIG. 3A, after the list code creates the image for the blank list (unpopulated by data), a data structure is initialized. In one embodiment, an array could be used, with one entry for each item in the list. This array will indicate whether the list has data populated for that particular entry corresponding to the index. Thus, if the third element to the array indicates data has been populated, then the third item in the list 370 would have data. That data structure is initialized so that all of the entries indicate no data populated. In another embodiment, a hash table can be used to store the indication of whether each of the items in the list have data. In step 222, the image created in step 218 is assigned to the container in the user interface for displaying the list. That container will include a scroll bar to scroll within the list. As the user scrolls, the visible area of the list will change. For example, the list 370 would be moved up or down with respect to rectangle 380.

In step 224, list code 306, will assign a hover item to the list. If a user causes the pointing device (e.g., cursor) to be positioned over an item in the list, a hover action is performed. The hover action is performed according to the hover item which is attached to the list in step 224. In one embodiment, the hover action could be to highlight the particular item (e.g., reverse the colors, change the background, add a border, etc.).

In step 226, application code 304 requests that list code 306 report indices of list items that are visible. In one embodiment, application code 304 will use the GetVisibleIndices module function 350 to acquire the start and ending indices of those items in list 370 that are visible to a user. In step 228, list code 306 will provide those indices to application code 304. In step 230, application code 304 will request data from server 30 for all of the items that are visible, based on the indices returned from list code 306. Web server 30 will return that data as part of step 230. In step 232, application code 304 provides that data returned from web server 30 to list code 306. For example, in one embodiment of step 232, application code 304 will call SetItem 348 module for each index for which data has been received. Each call to SetItem module 348 will include an index and data for that index. In step 234, list code 306 will create images that depict the received data and will replace the placeholder images with the new images created. For example, placeholder image of FIG. 7A will be replaced with the image of FIG. 7B, as discussed above. In one embodiment, a placeholder image is replaced with an image that depicts the data by overlaying the placeholder image with the image that depicts the data. In another embodiment, the placeholder image is edited to add the data. In another embodiment, the placeholder image is deleted and replaced with the new image that depicts the data.

FIG. 3B is a flowchart describing another embodiment for creating a list. The process of FIG. 3B corresponds to the system of FIG. 1B. In step 250, application code 304 and list code 306 are loaded onto a client machine as part of the application 52, as part of a plug in, or another means. In step 252, the loaded code is executed by client 50. In step 254, application code 304 will send a request to server 62 (via network or other medium 60) asking how many items will be in the list. In step 256, the server replies with the number of items in the list. In step 258, application code 304 requests that list code 306 create the list with the number of items specified by server 62. In step 260, list code 306 determines the size of the image representing the list. In step 262, list code 306 will initialize the data structure, as described above. In step 266, list code 306 will cause the image to be displayed as part of the user interface. In step 268, list code 306 will assign the hover item to the list. In step 270, application code 304 requests that list code 306 indicate the start and end indices for the visible items of the list. In step 272, list code 306 will provide the start and end indices of visible items to application code 304. In step 274, application code 304 sends a request to server 62 asking for data for the visible items. The server will return that data as part of step 274. In step 276, application code 304 will provide the data returned from server 62 to list code 306. In step 278, list code 306 will replace the placeholder entries in the list with the data image, as described above with respect to FIG. 3A.

Once the list is created, the user can then interact with the list. One advantage of the technology described herein is that the user is allowed to interact with the list before all of the data is loaded into the list. Thus, the user can scroll within the list even if all the data is not available to display to the user. The user can also add new items to the list, delete items in the list, select items in the list, hover over items in the list and/or do other actions to items in the list without the data for the items being loaded yet. For example, as the user scrolls within the list, if the data for a particular item being displayed on that portion of the list scrolled to is loaded, the user will see that data. If the data has not already been loaded from the server, the user will see the placeholder image of FIG. 7A in the place for the particular item. The scroll bar (including the slider) will be sized and positioned as if the list were completely populated with data. Thus, if the user has scrolled halfway down the entire list, the scroll bar would indicate halfway through the list. Additionally, as is customary with many applications, the thickness of the slider on the scroll bar will be proportional to how many items are in the list (even if some of the items have not been populated with data). The thickness of that slider of the scroll bar will be set according to the number of items in the list, regardless of whether those items have all been populated with data.

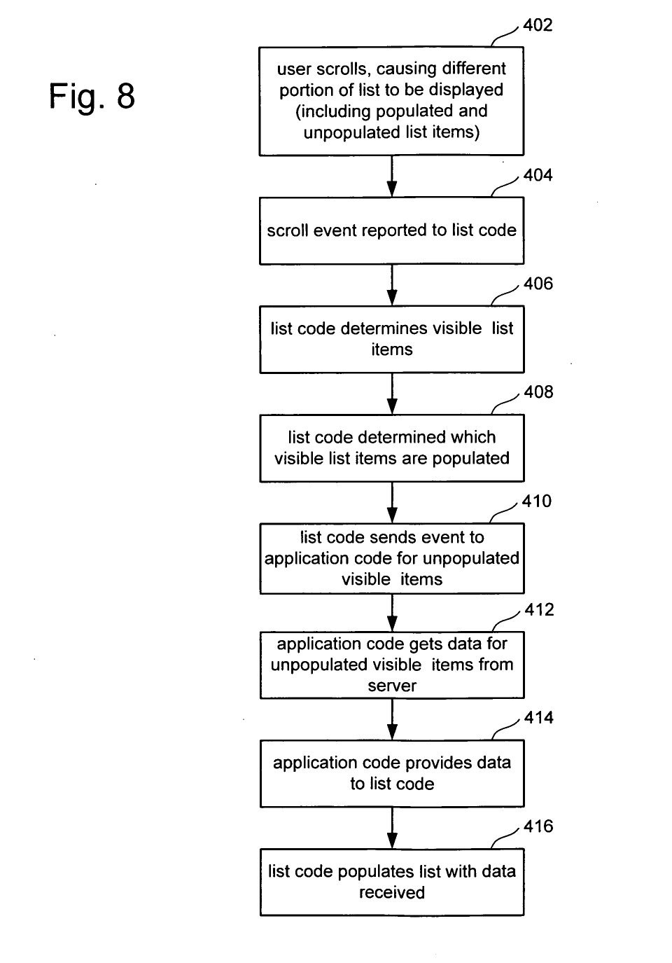

FIG. 8 is a flowchart describing one embodiment of how the system manages a list while a user is scrolling. In step 402, the user scrolls by dragging the slider for the scroll bar. The scrolling causes different portions of the list to be displayed, including portions of the list with items populated by data and portions of the list with items not populated by data. When the user stops scrolling, a scroll event is reported to list code 404. In one embodiment, the scroll event can be reported when the user lets go of the pointing device, stops scrolling or during the scrolling. In step 406, list code 306 determines which part of the list is visible. Based on slider position in the scroll bar, height of each item, the number of items in the list and the size of the viewable portion of the list, the system determines the position of the visible portion of the list in comparison to the rest of the list. Step 406 includes determining a start index and an ending index for the visible portion of the list. In step 408, the list code 306 determines which of the visible items are populated with data. The indices determined in step 406 are used to access the data structure (see steps 220 and 264) to determine if the data structure indicates that the particular items are populated with data or not populated with data. In step 410, list code 306 sends an event to application code 304 requesting that the unpopulated items receive data. That event will indicate a code requesting data and also indicate the indices that need data. In step 412, application code 304 will acquire the requested data from the server. In step 414, application code 304 provides the data to list code 306 using, for example, the SetItem module 348. In step 416, list code 306 populates the list with the new data received by creating new images and overlaying those images over the placeholder images, as discussed above.

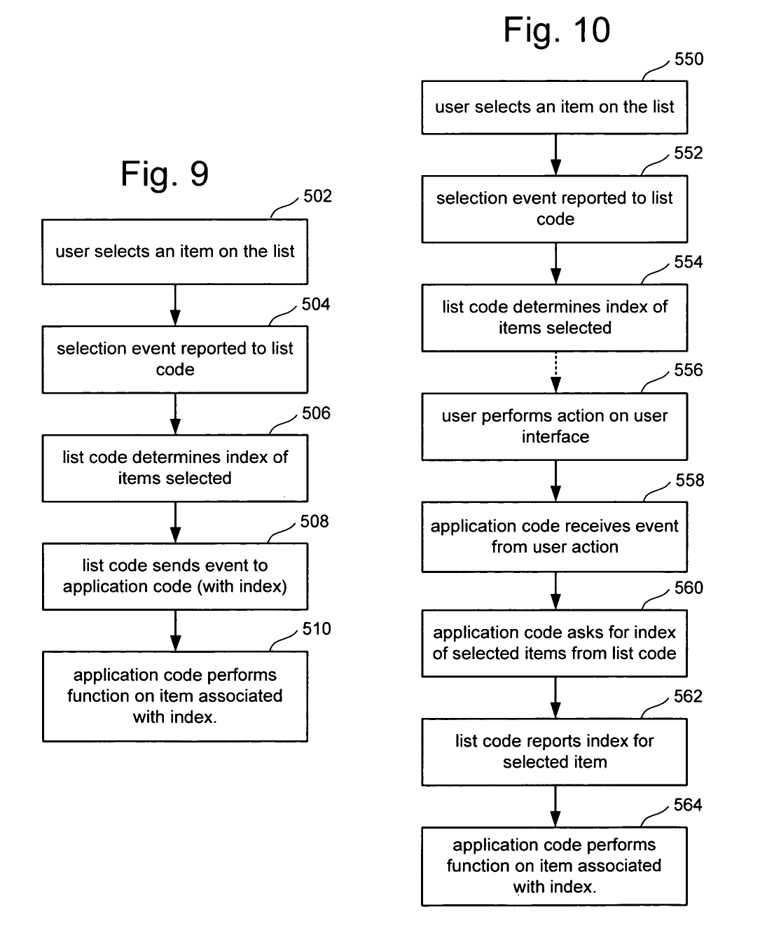

FIGS. 9 and 10 provide flowcharts depicting two embodiments for processes performed when the user selects a particular item in the list. In step 502 of FIG. 9, the user selects an item in the list. In one implementation, the user can select an item by single clicking on the item using a mouse. In another embodiment, the user can select the item by double clicking. Other means for selecting can also be used. The particular means implemented is likely to be predetermined and coded into the system. In one embodiment, merely selecting an item caused a particular action to be performed. In another embodiment, selecting an item will only mark the item for future use, but not cause anything to be performed. In one example implementation, single clicking on an item will merely select the item, while double clicking the item will select the item for a predetermined operation to be performed (e.g., such as opening the item). It is assumed that in FIG. 9 the item is selected in step 502 by double clicking the item so the item will have an operation performed on it (e.g., opening the item or another operation).

In step 504 of FIG. 9, the selection event is reported to list code 306. In step 506, the list code determines the index of the item selected. In one embodiment, the selection event will report the coordinates on the screen of the cursor when the item was selected. By knowing which items are visible and the height of each item, the system can mathematically determine which item was selected in step 506. The index of that item is then identified as the selected item. In step 508, the list code will send an event to application code 304. That event will include the index identified in step 506. In step 510, application code 304 will perform a function on the item associated with index identified to it in step 508. In one embodiment, application code 304 will send a request for all the data associated with that item to the server. Upon receiving the data from the server, more information about the item can be displayed. For example, if the list corresponds to a list of email messages (e.g., an inbox), then double clicking in step 502 will cause the entire message to be displayed in step 510. In some embodiments, the entire message can be displayed in response to one click or pushing a special button. In another embodiment, the function performed in step 510 could include deleting, editing, forwarding, replying or otherwise operating in the selected item.

FIG. 10 is a flowchart describing another embodiment of a process for responding to the selection of an item in the list. In step 550, the user selects an item in the list using any of the means discussed above. In one example, the user clicks on the item with a mouse or other pointing device. In step 552, a selection event is reported to list code 306. In step 554, list code 306 determines the index of the item selected, as described above. Note that the arrow between steps 554 and 556 is dotted because it is contemplated that an unpredictable amount of time may occur between step 554 and step 556. After selecting an item, a user may select a function key anywhere on the user interface. For example, the user may select an email message and then click on an Open button, Delete button, Forward button, Reply button, etc. Thus, step 556 represents a user performing an action on the user interface such as pressing a button, choosing a menu selection, etc. In step 558, the application code 304 receives the event from the user action in step 556. In step 560, the application code asks for the index of the selected item from list code 306. In one embodiment, application code 304 will call the GetSelectedIndex module 344 to acquire the index for the particular item selected. In one embodiment, multiple items can be selected and list code will return multiple indices in step 562. In step 564, the application code 304 will perform the function associated with the user action in step 556 on the item selected.

The functions performed on the items described above with respect to FIG. 9 and FIG. 10 can be performed on the item selected if the item has data populated or if the item did not yet have data populated. If the item did not yet have data populated, then the list will show the placeholder image. The user can select a placeholder image by single clicking, double clicking, etc. The appropriate index will then be reported to the application code and the application code can get the actual data from the server for that index and perform the action of that index even if that data was not depicted or populated in the list. In some cases, the data will be used to populate the selected item while, before or after the function is performed.

It is contemplated when the user scrolls to a new part of the list, the list may initially show the placeholder images. Eventually, the list will be populated with data and those placeholder images will be replaced by actual data. But, as described above, the user can select one of the placeholder images before the data is populated and perform an action on those images. The particular actions performed are application specific. For example, with an email application, an email message can be opened, highlighted, deleted, replied to, forwarded, etc. In an online banking application, checks can be highlighted, sorted, deleted, added, edited, etc. Search results can be opened or otherwise modified. Other applications will have other actions associated with the various items in the list. The technology described herein for maintaining a list is not restricted to any particular application.

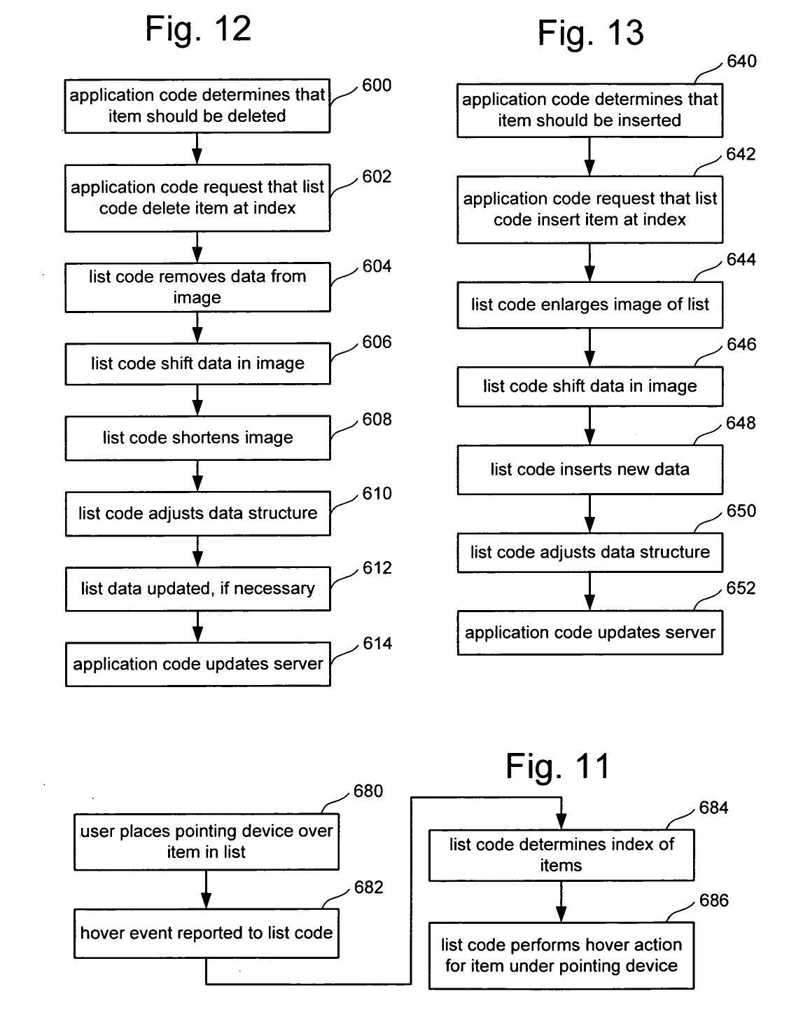

FIG. 11 is a flowchart describing one embodiment of a process performed when the user hovers a pointing device over a particular item in the list. In step 680, the user places the pointing device over the item in the list. The item can be populated with data or unpopulated with data. If the item is unpopulated with data, then the user will be placing the pointing device over placeholder image of FIG. 7A. In step 682, a hover event is reported to list code 306. In response to that hover event, the list code determines the index of the item or items. In one embodiment, multiple items can be hovered over. When a hover event is reported to list code 306, the system reports coordinates of the point device. Because the list code knows which items are visible and the height of each item, the list code can determine which item is below the cursor. In step 686, the hover action is performed for the item underneath the pointing device. In one embodiment, the hover action includes highlighting the item (e.g., reversing the colors, shading, thick border, etc.). In other embodiments, the hover action could include popping up a small window describing the item, providing more data for the item (if such data is available) or performing an action on the item. The process of FIG. 11 can be performed, including performing the hover action, for items that are populated with data or items that have not yet been populated with data.

FIG. 12 is a flowchart describing one embodiment of a process for deleting an item in the list. In step 600, application code 304 determines that a particular item should be deleted. In one embodiment, application code 304 can determine an item should be deleted because a user selected an item (as described above) and then chose a button or menu item indicating that the item should be deleted. In another embodiment, application code 304 can determine that an item should be deleted based on the server, a menu, or other action. In step 602, application code 304 requests list code 306 delete the particular item. That is, application code 304 will call DeleteIndex module 342, passing a particular index as an argument to that function. List code 306 will remove the image for the item at the particular index passed in with the function call. If there is no data populated, then the placeholder image would be removed. In step 606, all of the images that come after the index being deleted are shifted up in the image of the list and (in step 608) the image is shortened to accommodate for the removed list item. In step 610, the data structure that indicates whether each of the list items are populated with data or not is adapted to remove the particular entry associated with the removed data and all of the other entries are then shifted up or otherwise adjusted accordingly. In step 612, data from the list may be updated, if necessary. That is, if the deleted item was visible, then when the list is adjusted a new item would become visible. If that new item does not have data, then it is populated with data using the processes described above. If the item that just became visible already had data, then new data would not be acquired in step 612. In step 614, application code 304 will update the server (if necessary) to indicate that the particular item was removed.

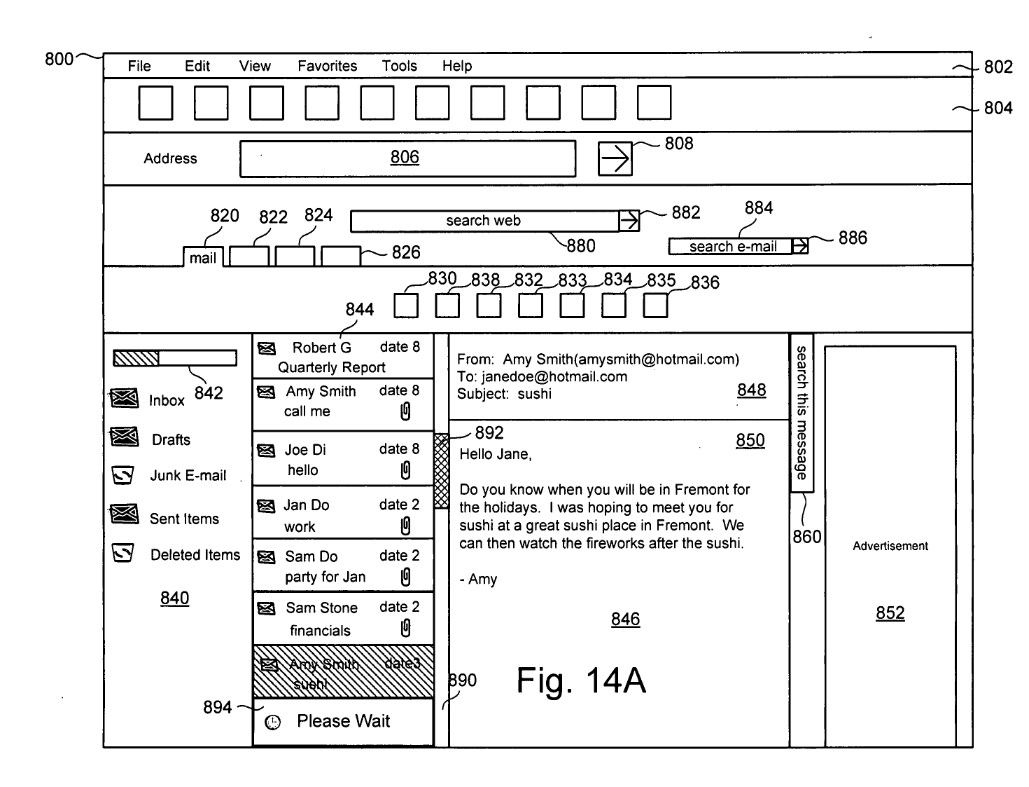

FIG. 13 is a flowchart describing one embodiment of a process for adding a new item to a list. In step 640, application code 304 determines that a new item should be inserted. Step 640 can be performed in response to an indication from the server or from the user using a button or menu option on the user interface. Other means for determining that items should be inserted can also be used. In step 642, application code 304 requests that the list code insert an item at a particular index. The list code will then enlarge the image of the list by one item. The images of the items will be shifted. The new image for the new item be inserted into the image. If the request to add the new item included data, that data would be used to create a new image such as that of FIG. 7B and added to the image at the appropriate place according to the new index. That new index can be anywhere in the list. If the request to add the new item to the list does not include data for that new item, then in step 648 the placeholder image is added to the list. In step 650, the data structure that indicates which items have been populated with data is adjusted to add a new data item. In step 652, application code 304 reports to the server that a new item has been added.

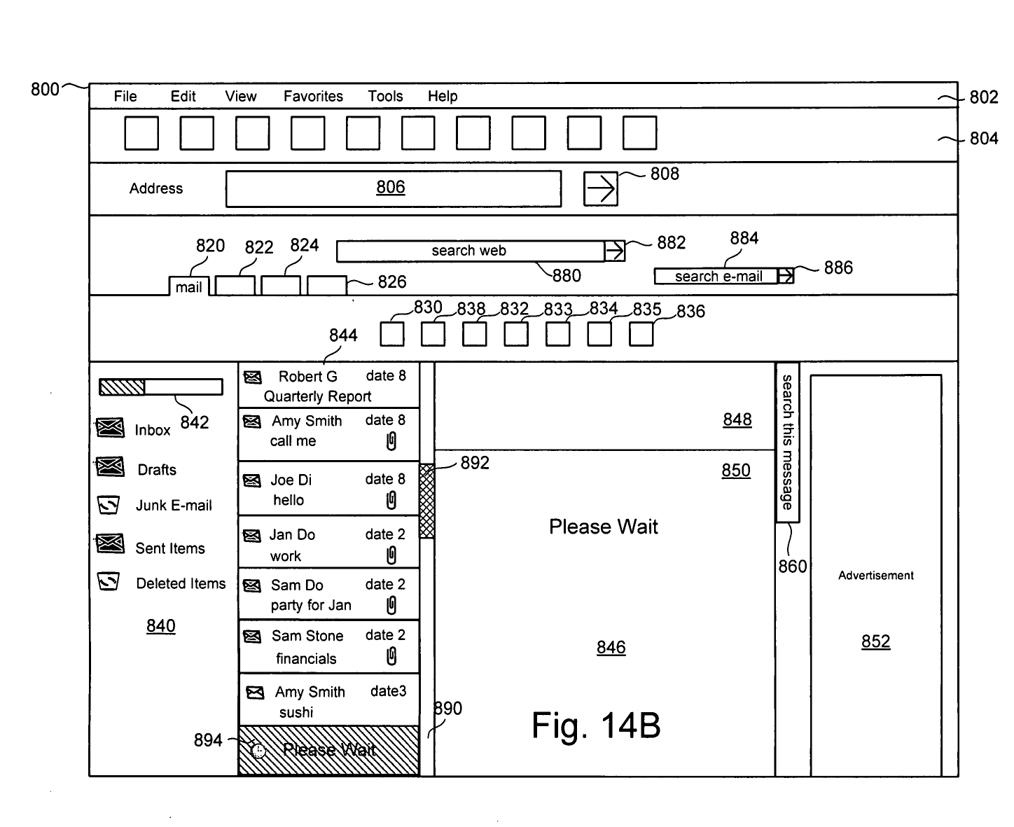

FIGS. 14A and 14B provides an example of a messaging user interface 800. In one embodiment, messaging user interface 800 is provided in connection with an email system. The embodiment depicted in FIG. FIGS. 14A and 14B is for a web-based email system. In other embodiments, other types of email systems can be used. Messaging user interface 800 includes toolbar 802 with several drop down menus. Each drop down menu is identified by a title such as File, Edit, View, Favorites, Tools, and Help. In one embodiment, messaging user interface 800 is provided within an Internet browser. One example of an Internet browser is Internet Explorer from Microsoft Corporation. Messaging user interface 800 also includes toolbar 804, which includes several tools associated with the browser. The browser also includes an address field 806 and a “go” button 808. By inserting an address in address field 806 and selecting “go” button 808, the browser navigates to the address inserted in the address field 806. A user attempting to use the browser to access an email system would insert the address for the email system in address field 806.

Messaging user interface 800 includes a search field 880 for entering search terms in order to search on the Internet (or within another domain). After entering a search term in field 880, the user would select button 882 to initiate the search. Additionally, search field 814 is provided to enter search terms that will be used to search through various messages in the email system. By entering a search term in field 814 and selecting button 816, that search will be commenced. User interface 800 also includes a series of buttons 830, 838, 832, 833, 834, 835 and 836 (more or less buttons can also be used). These buttons will have various functions depending on the particular mode of the email system. For example, the buttons can be used to reply to a message, forward a message, delete a message, compose a new message, move the message to a new folder, order the arrangement of messages, or provide other tools.

Messaging user interface 800 also includes a folder list 840 which lists various folders. In one example, the folders include an Inbox, Drafts, a Junk Email folder, a Sent Items folder, and a Deleted Items folder. Other folders can also be used. Folder list 840 includes a usage bar 842, which indicates how much of the available storage is being used. The gray portion of the bar indicates storage space used and the blank portion of the bar indicates free space.

Messaging user interface 800 also includes message list 844, which lists all the messages in a selected folder. The message list may have hundreds of messages and, therefore, is implemented with the list technology described herein. If the Inbox is selected in folder list 1840, then message list 844 will represent the inbox and list all the emails in the Inbox. The message list 844 will work similarly for other folders. Message list 844 is a list, as described above. Each item in the list, when populated with data, will indicate the sender, the subject, date, and whether any attachment is included (e.g., by displaying a paperclip). By selecting one of the messages in the message list 844 (see shaded message from Amy Smith on date 3 in FIG. 14A), the selected message is depicted in review panel 846. In one embodiment, by double clicking on a message in message list 844, a separate window can be opened to view the particular message. Review panel 846 shows the header portion of 848 and the body 850 of the message.

Message list 844 has a scrollbar 890 with a slider 892. The height of the slider is proportional to the number of items on the message list 844. As the slider is moved up or down, a different portion of message list 844 will be depicted. The portion of the message list depicted in FIGS. 14A and 14B shows seven items that have been populated with data and one item 894 that has a placeholder image. It is likely that the system will acquire the data shortly after item 894 becomes visible—this may happen before, after or during an action being performed on item/message 894.

FIG. 14A depicts the message from Amy Smith on date 3 being selected and depicted in review panel 846. FIG. 14B depicts the unpopulated message 894 being selected and depicted in review panel 846.

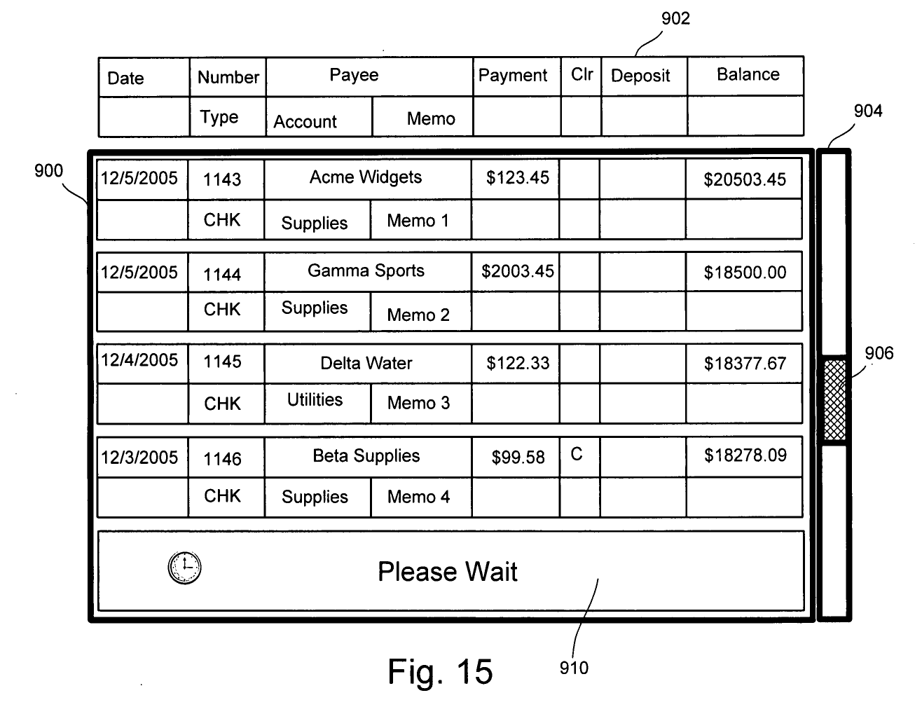

FIG. 15 provides another embodiment of a user interface that uses a list as described above. User interface of FIG. 15 is part of an online banking service, and depicts a portion of a check register. A check register includes check list 900, header 902 and scroll bar 904. Header 902 indicates the data in each list item. Check list 900 includes hundreds of items; however, only five items are depicted. Check list 900 is a list in accordance with the technology described herein Each item represents data for a check. The five items visible include data for checks 1143, 1144, 1145, and 1146 as well as item 910 for which data has not yet been populated. To see other checks, the user would move slider 906 up and down within scroll bar 904. As slider 906 moves up scroll bar 904, the list moves toward the top of the list. As slider 906 moves down scroll bar 904, the list moves toward the bottom of the list. Over time, the system will acquire data for the fifth item 910, create a data image, and add that data image to check list 910. If the user scrolls to a portion of the list which has items not populated with data, rather than seeing the information for a check the user will see placeholder images. The user can click on any of the checks or any of the placeholder images in order to delete that item, edit that item, open that item or otherwise manipulate that item as described above. Any of the functions described above can be performed in the list depicted in FIG. 15.

The above discussion used vertical lists as examples of lists that can use the technology described herein. However, other types of lists can also be used, including lists in a horizontal configuration, lists in a tiled configuration, as well as other configurations. Additionally, the data in the lists need not be alpha-numeric. Other types of data can also be used. Some examples of other types of data include (but are not limited to) audio data, video data, image data, windows, user interface elements, icons, etc. One example includes a user interface for exploring a 3-D world, where the 3-D world includes a set of regions and/or set of items to interact with. The set of regions or set of items can be the list. Consider a 3-D world divided into a set of regions, where some of the regions are on the border of the viewable portion of the 3-D world. When a user interacts with a region on the border region, neighboring regions are displayed using placeholder images until data can be retrieved for the neighboring regions. In other embodiments, instead of a 3-D world, almost any kind of environment or user interface can be used. For example, a map can be explored, where each region on the map can be a member of the list.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. It is intended that the scope of the invention be defined by the claims appended hereto.

We claim:

1. A method for providing a list, comprising:
providing a representation of said list that depicts items in said list that have not been populated with data;
receiving a request to perform an action on an item that has not been populated with data; and
facilitating performance of said action on said item.

2. A method according to claim 1, wherein:
said providing a representation includes creating an image of said list that comprises a plurality of placeholder images; and
said providing a representation further includes adding a data image on top of one of said placeholder images after data has been received for an item.

3. A method according to claim 1, wherein:
said providing a representation includes creating an image of said list that comprises a plurality of placeholder images; and
said providing a representation further includes requesting data for an item after said item has become visible, receiving data for said item in response to said request, creating a data image for said data, and adding said data image on top of one of said placeholder images.

4. A method according to claim 1, further comprising:
receiving a selection of an item in said list before said item has been populated with data, said receiving a selection includes:
receiving a selection event that identifies a location,
determining that said item was selected based on said location, and
changing said item in response to said determining.

5. A method according to claim 1, wherein:
only a portion of said list is visible on a user interface;
said user interface includes a scroll bar for said list;
said list scrolls in response to said scroll bar; and
data is accessed and added to particular items that has not been populated with data when said list scrolls to view said particular items.

6. A method according to claim 1, wherein:
said action includes a hover action.

7. A method according to claim 1, wherein:
said action includes deleting said item.

8. A method according to claim 1, wherein:
said action includes selecting said item.

9. One or more processor readable storage devices having processor readable code embodied on said processor readable storage devices, said processor readable code for programming one or more processors to perform a method comprising:
providing a representation of a set of items that depicts at least a subset of said items that have not been populated with data; and
filing in data for items that have not been populated with data after providing said representation.

10. One or more processor readable storage devices according to claim 9, wherein:
said providing a representation includes creating an image of said items that comprises a plurality of placeholder images.

11. One or more processor readable storage devices according to claim 10, wherein:
said filling in data includes requesting data for an item after said item has become visible, receiving data for said item in response to said request, creating a data image for said data, and adding said data image on top of one of said placeholder images after data has been received for an item.

12. One or more processor readable storage devices according to claim 9, wherein:
said set of items are display items of a user interface;
a subset of said display items are on one or more edges;
said providing a representation includes displaying one or more additional items when a user interacts with a display item on one of said one or more edges without displaying data for said one or more additional items; and
said filling in data includes acquiring data for said one or more additional items after displaying said one or more additional items.

13. One or more processor readable storage devices according to claim 9, wherein:
only a portion of said list is visible on a user interface;
said user interface includes a scroll bar for said list;
said list scrolls in response to said scroll bar; and
said filling in data includes accessing data and adding said accessed data to particular items that has not been populated with data when said list scrolls to view said particular items.

14. One or more processor readable storage devices according to claim 13, wherein:
said accessing data includes identifying indices for said particular items, determining whether said particular items have been populated with data, and making a request for data to a server that provides a service over a network.

15. One or more processor readable storage devices according to claim 9, wherein:
said providing a representation and filling in data is performed without a page refresh.

16. One or more processor readable storage devices according to claim 9, wherein:
said list is an email inbox.

17. An apparatus, comprising:
a communication interface;
an output device;
an input device;
one or more processors in communication with said communication interface, said output device and said input device; and
one or more storage devices in communication with said one or more processors, said one or more storage devices include list code, said list code manages and provides a representation of said list on said output device, only a portion of said list is viewable on said output device at a given time, said list code depicts items in said list that are visible but have not been populated with data, said list code fills in data for items that have not been populated with data after said items have become visible in response to said list being manipulated to show a different part of said list, said list is manipulated using said input device.

18. An apparatus according to claim 17, wherein:
said list code is part of an application resident on said apparatus;
said list code receives said data from application code stored on said one or more storage devices; and
said application code receives said data from a server in communication with said application code via said communication interface.

19. An apparatus according to claim 17, wherein:
said list code is downloaded to said apparatus from a server;
said list code runs from within a browser on said apparatus;
said list code receives said data from application code stored on said one or more storage devices; and
said application code receives said data from said server as part of a web based service.

20. An apparatus according to claim 17, wherein:
said list code receives a request to perform an action on a particular item that has not been populated with data and facilitates commencement of performance of said action on said particular item before said particular item is populated with data.
